(19) United States
(12) Patent Application Publication
(10) Pub. No.: US 2021/0307875 A1
(43) Pub. Date: Oct. 7, 2021

(54) DRILL TEMPLATE FOR DRILLING AN IMPLANT HOLE FOR A DENTAL IMPLANT

(71) Applicant: EXOCAD GMBH, Darmstadt (DE)

(72) Inventors: Andreas LOEB, Darmstadt (DE); Michael PRAGER, Darmstadt (DE); Sebastian RUEHL, Darmstadt (DE); Paul SCHNITZSPAN, Darmstadt (DE)

(21) Appl. No.: 17/283,525

(22) PCT Filed: Oct. 10, 2019
(86) PCT No.: PCT/DE2019/100876

§ 371 Date: Apr. 7, 2021

(30) Foreign Application Priority Data
Oct. 10, 2018 (DE) 10 2018 007 982.2

(51) Int. Cl. A61C 1/08; A61C 17/02

(52) U.S. Cl. CPC A61C 1/084; A61C 17/0208

(57) ABSTRACT

The invention relates to a drill template for drilling an implant hole for a dental implant, the drill template having a through-opening and at least one aperture, wherein the drill template is provided or can be placed for resting or bearing against a jaw, palate and/or one or more teeth and is at least partially adapted to the geometry of the jaw, palate and/or one or more teeth, wherein the through-opening is provided for guiding a drill, in particular a dental implant drill, and/or for inserting a guide sleeve for a drill, and wherein the aperture is provided for conducting a fluid, wherein the drill template comprises a fluid-conducting element.

### TECHNICAL FIELD

The invention relates to a drill template for drilling an implant hole for a dental implant, the drill template having a through-opening and at least one aperture. To this end, the drill template is provided or can be placed for resting or bearing against a jaw, palate and/or one or more teeth and is at least partially adapted to the geometry of the jaw, palate and/or one or more teeth. The through-opening is provided for guiding a drill, in particular a dental implant drill, and/or for inserting a guide sleeve for a drill, and the aperture is provided for conducting a fluid.

The invention also relates to a method for the virtual draft and/or production of a drill template for drilling an implant hole for a dental implant.

### RELATED PRIOR ART

Different drill templates in the field of dental implantology and also methods for producing a drill template are already known from the prior art.

These methods are based in principle on the fact that the jaw or the jaw surface, in particular also the palate and/or one or more teeth of a patient, is three-dimensionally (3D) recorded using a negative impression or using a computer-aided imaging method.

In addition, digital three-dimensional casting methods using intra-oral 3D scanners are known, with all systems currently on the market operating by means of photo-optical recording technology. For example, systems are known that are based on a triangulation method or on confocal imaging. In addition, other physical recording methods are also under discussion, for example sonography, recording by means of magnetic resonance tomography, by means of computer tomography, or by means of digital volume tomography.

In particular, the three-dimensionally imaging method is used to record in particular the oral cavity of the patient at least in some regions, which is then processed to form a data set, with the position and the orientation of the implant relative to the oral cavity or the positions and the orientations of the implant(s) relative to the oral cavity and/or to one another being recorded.

Based on this recording, in particular the data set generated from the recording, the placement of the implants in the patient's jaw can then be planned with three-dimensional (3D) visualisation. The implant planning of one or more implants is a prerequisite for determining the required through-opening in the drill template which is yet to be modeled. This is generally achieved using visualisation software, with a CAD-CAM (computer-aided design and computer-aided manufacturing) method being preferred.

A drill scheme or an associated drill template is then created, likewise virtually, and is produced in particular by means of a generic production method, such as the laser sintering method described by way of example in EP 1021 997 A1, or the stereolithography described by way of example in WO 97/29901 A1. If suitable materials for dental medical products are used, there is also no cause to criticize the described generic production method.

The previously recorded anatomical conditions or the data set generated therefrom, besides other data, also comprise the position data of the implant to be placed, which for example are related to different surfaces, Cartesian and/or angle coordinates, and are preferably stored in association with this recording.

As already noted, the position of the implant as well as its orientation are prerequisites when designing the virtual model of the drill template. One or more implants are taken into account in the drill template with one through-opening. The through-opening is provided here for guiding a drill, in particular a dental implant drill, and/or for inserting a guide sleeve for a drill. A hole in the jaw bone of a patient is created using the drill in order to then insert an implant into the resulting drilled hole. An approach of this kind is already known from DE 10 2016 004 641 A1.

In order to ensure a secure anchoring and healing of the implant in the jaw or jaw bone, it is necessary to perform the drilling process for preparing the implant bed without creating a harmful rise in temperature in the bone, which might be caused as a result of the drilling friction.

In order to accordingly avoid an inadmissibly high rise in temperature, a coolant, in particular water or a saline solution, is sprayed from the side onto the drill or is conducted as directly as possible through the drill shaft onto the contact area between the drill and bone, as proposed in DE 100 24 724 A1.

The necessary cooling, however, is only provided during operation of the drill and the cooling effect stops when the drilling instrument and thus also the drill has to be removed from the drill template, for example in order to remove saliva, blood and abraded particles from the drilled hole or when the drill itself needs to be changed.

A drill template on which the present invention is based is known from EP 0 774 238 A1 and is intended to improve the cooling and also the removal of saliva, blood and abraded particles during operation of the drill. To this end, the drill template has a lateral cutout in the drill template, which cutout also breaks into the drill channel laterally and thus forms an outlet for an introduced coolant, as well as saliva, blood and abraded particles.

The previously known prior art, however, entails the problem that the coolant accumulates in the patient's throat area together with saliva, blood and abraded particles. The swallowing reflexes triggered as a result, together with wretching, are extremely unpleasant for the patient and also the dentist and make it difficult to perform the treatment in a precise manner.

The treatment, in particular the drilling process, then has to be interrupted frequently in order to suction the coolant together with saliva, blood and abraded particles, which extends the duration of the treatment and also increases the costs accordingly.

The suctioning is performed in most cases by assistant staff, using what are known as saliva ejectors which are connected to suction units.

The object of the invention is therefore to now design and refine the drill template described at the outset in such a way that the drilling can be performed as a preparatory measure for the placement of an implant more easily, more quickly and more economically, which thus results in advantages for the patient, specifically in particular a reduced treatment duration and a more comfortable treatment itself, as well as advantages for the dentist performing the treatment, specifically lower resultant costs and increased patient satisfaction.

A further object of the invention is to provide a method with which a drill template can be designed in a virtual manner and/or can be produced.

### DISCLOSURE OF THE INVENTION

The above-mentioned objects are solved initially in that the drill template has a fluid-conducting element.

Since the drill template is now designed such that the drill template has a fluid-conducting element, a permanent suctioning can be provided, and an accumulation of coolant in the patient's throat region together with saliva, blood and abraded particles can be prevented or at least mitigated.

Due to the suctioning, a permanently applied negative pressure is also generated between the drill template and the jaw or palate, whereby the drill template experiences an additional adhesion to the jaw or palate and therefore remains securely in the intended target position on the patient's jaw even if it is not manually fixed in place by the dentist.

To this end, a plurality of fluid-conducting elements may also be provided in order to boost the suction effect and/or the adhesion.

A fluid-conducting element for introducing a fluid into the drill template, in particular substantially in the vicinity of the implant bed or the drilled hole, may also be provided.

An uninterrupted cooling of the implant bed without a traumatising rise in temperature in the bone may be ensured as a result, even if there is no coolant flow coupled to the drilling instrument or if the drill has been removed from the drill template.

In particular, a gaseous fluid may also be introduced as coolant via the additional fluid-conducting element, which fluid provides effective pain relief for the patient and whereby an accumulation of further coolant in the throat region is also avoided.

The above-stated object—with regard to the method—is also now achieved firstly in that, in particular, the position or location and orientation of the through-opening and of the aperture and of the fluid-conducting element, in particular their course, is taken into account for the virtual draft and/or production of the drill template under consideration of the position of location and orientation of the implant defined in the virtual implant plan.

The disadvantages discussed at the outset are therefore avoided and corresponding advantages are achieved.

There are now a multitude of possibilities for designing and refining the drill template according to the invention and the method according to the invention advantageously. To this end, reference should be made firstly to the claims dependent on claim 1 and on claim 19.

The dependent claims relate to preferred embodiments.

In one embodiment of the drill template, the fluid-conducting element has an inlet and an outlet, wherein the fluid-conducting element is fluidically effectively connected or connectable to the aperture through the inlet, whereby a fluid can be supplied or discharged into/from the immediate surroundings of the implant bed. In addition, drilling residues, such as bone splinters, may also be removed, in particular suctioned away.

It is additionally advantageous if the aperture has a specific orientation, so that this may be easily moulded on the fluid-conducting element or the fluid-conducting element may be easily guided through the aperture without forming a constriction.

To additionally improve patient comfort, the outlet of the fluid-conducting element is oriented substantially towards the mouth opening (labially) or alternatively towards the cheek (bucally). This is particularly space-saving and thus also leaves more space to guide the drilling instrument.

Since the fluid-conducting element has a tubular or a flat-rectangular cross section, the fluid-conducting element may be easily moulded on one of the walls of the drill template, or alternatively is an integral part of the drill template. A design of the fluid-conducting element in which it is provided partially or wholly below the surface or the wall of the drill template, therefore is not visible at all or is not fully visible, is particularly preferred. To this end, the fluid-conducting element may run in/on the outer wall oriented outwardly in the tooth region (vestibularly), towards the cheek, in/on the inner wall oriented towards the interior of the mouth (inwardly in the tooth region, orally), or in/on the upper wall oriented towards the line of terminal occlusion (occlusally), wherein the fluid-conducting element is provided at least partially on and/or in one of the walls or is formed integrally with one of the walls.

In a further embodiment, the drill template may have a cavity which is surrounded or formed by the outer wall and inner wall. To this end, the inner and the outer wall are provided resting against the gingiva and seal off the cavity with respect to the throat region. Since the cavity is additionally fluidically effectively connected to the through-opening, a type of “collection space” is hereby provided in the drill template. In particular, the drilling residues, such as bone splinters, are received in the collection space if they are unable to be suctioned away due to their size and would consequently clog the fluid-conducting element. In order to prevent even the entry of large drilling residues into the fluid-conducting element, it is conceivable to arrange a filter or a mesh-like element between the inlet of the fluid-conducting element and the aperture.

In order to achieve a sufficient suction effect at the inlet of the fluid-conducting element, a connection for suctioning by a conventional dental suction unit may be attached to the outlet of the fluid-conducting element. The connection or the connection geometry of the external suction unit may for this purpose be considered already during the virtual draft for producing the drill template and may be selected from a catalogue or from a database of manufacturer-specific connection geometries stored in the CAD/CAM software.

The virtual draft of the drill template provided at the start, for calculating or defining the fluidic element, has at least one inlet coordinate KE of the inlet and an outlet coordinate KA of the outlet and also a cutting line S, with the cutting line S connecting the inlet coordinate KE and the outlet coordinate KA to one another linearly. In particular, the cutting line S is formed as what is known as a spline. The cutting line, and therefore ultimately also the fluid-conducting element, is preferably calculated automatically and integrated into the design of the drill template. To this end, the cutting line or the course is planned under consideration of the position or location and orientation of the implant defined in the virtual implant planning. In particular, the direction of insertion of the implant may also be taken into account. Furthermore, what are known as “viewing windows”, “ribs” and the “clear width” (inner diameter) particularly at/in the curved regions of the fluid-conducting element are also considered. Further coordinates for forming/calculating the cutting line may also be added manually or the cutting line or the course of the fluid-conducting element may be manually discarded entirely. To this end, at least the inlet coordinate KE and the outlet coordinate KE are preferably selected on one or more walls or on the surface of the virtual draft, with part of an aperture also being represented by the inlet coordinate KA. In other words, the coordinates that map the aperture at least also include the inlet coordinate KE. The cutting line or the course of the fluid-conducting element is then calculated or formed by a CAD/CAM system on the basis of the selected coordinates. This makes the subsequent production by a generic method particularly quick and cost-efficient.

In a further embodiment, which can also be produced by means of a generic manufacturing method, the fluid-conducting element has a branching, in particular a plurality of branchings, with each branching having an associated inlet. The fluid-conducting element may also have more than one outlet. Furthermore, the fluid-conducting element may also have a variable inner diameter which takes into account the number of branchings and associated the pressure loss. A fluid and/or a liquid and/or a solid drilling residue can thus be removed from the oral cavity, in particular from the implant bed or the cavity, simultaneously or concurrently at different points in the oral cavity.

In a further embodiment it is also possible to introduce a fluid into the drill template, in particular in the vicinity of or directly at the implant bed or drilling location through a further (second, third or fourth) fluid-conducting element. A permanent cooling and/or a permanent flushing of the implant bed can thus be ensured, without the need for a fluid flow through the drilling instrument. To this end, a gaseous fluid can be introduced particularly preferably in the vicinity of or directly at the implant bed or drilling location.

In a further embodiment the drill template may also have what is known as a “rib”. The drill template can be structurally reinforced by the bar and/or the bar may form an additional resting point on the patient's jaw. The “rib” may advantageously also be designed as a fluid-conducting element, or the fluid-conducting element may be designed at least in part as an integral part of a bar which structurally reinforces the drill template.

A number of preferred embodiments examples of the invention will be explained in greater detail hereinafter with reference to the following drawings and the associated description.

### BRIEF DESCRIPTION OF THE FIGURES

The drawings show:

FIG. 1 a schematic three-dimensional depiction of the drill template according to the invention, specifically showing the outer wall oriented towards the cheek (vestibularly) and the upper wall oriented towards the line of terminal occlusion (occulsally), and

FIG. 2 a schematic three-dimensional depiction of the drill template according to the invention from below, specifically in particular showing the resting surface, and

FIG. 3 a schematic three-dimensional depiction of the drill template according to the invention, specifically from the front, and

FIG. 4 a schematic three-dimensional depiction of the drill template according to the invention, specifically in a perspective view from the side with a further fluid-conducting element, and

FIG. 5 an enlarged detail from below of the drill template shown in FIG. 4 with a branching, and

FIG. 6 shows a more schematic sequence for generating a virtual draft of a drill template according to the invention and/or for producing a drill template according to the invention for drilling an implant hole for a dental implant.

### DESCRIPTION OF THE PREFERRED EMBODIMENT

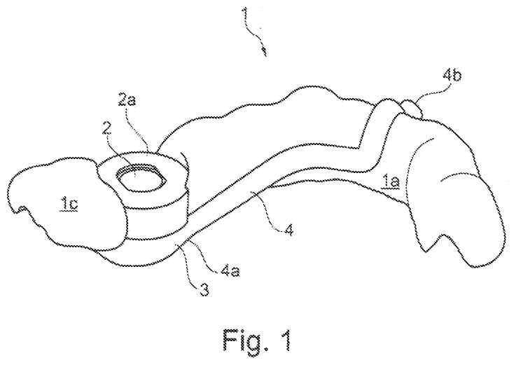

Before the corresponding method steps are described in greater detail, the drill template 1 and its essential components will first be discussed in greater detail hereinafter with reference to FIG. 1.

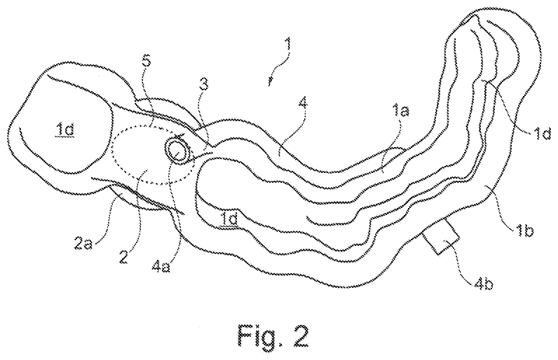

FIG. 1 shows a drill template 1 for drilling an implant bore for a dental implant (not shown), with a through-opening 2 and at least one aperture 3 (not visible in the figure; see also FIG. 2). The through-opening 2 is provided for guiding a drill (not shown), in particular a dental implant drill, and/or for inserting a guide sleeve (not shown) for a drill. In order to ensure sufficient stability of the drill template 1 during the drilling process, a reinforcement region 2a is provided around the through-opening 2. The reinforcement region 2a is preferably annular or cylindrical. It can also be clearly seen that the drill template 1 is provided or can be placed for resting or bearing against a jaw, palate and/or one or more teeth (not shown) and is at least partially adapted to the geometry of the jaw, palate and/or one or more teeth. Accordingly, the resting surface 2d (not visible in the illustration; see also FIG. 2) is also shaped to ensure that the drill template 1 sits in place an exact manner. The aperture 3 is positioned below the reinforcement region 2a so as to conduct a fluid, in particular to suction away a coolant together with saliva, blood and abraded particles, and is fluidically effectively connected to a fluid-conducting element 4. To this end, the inlet 4a of the fluid-conducting element 4 bears sealingly and fluidically effectively around the aperture 3, or the fluid-conducting element 4 reaches through the aperture 3 and ends below the reinforcement region 2a so that the inlet 4a is exposed there (see also FIG. 2). Depending on the orientation of the aperture 3, wherein the orientation is determined or calculated on the basis of a direction vector, the direction vector being determined or calculated in particular with at least one implant (reference) coordinate KI, the aperture 3 and therefore also the inlet 4a of the fluid-conducting element 4 surrounding the aperture 3 can assume a fluidically optimised orientation. The fluid-conducting element 4 is also tubular in this illustration. Alternatively, however, a flat-rectangular cross section is also conceivable. Also clearly visible is the outlet 4b of the fluid-conducting element 4, which is oriented or positioned in principle substantially towards the mouth opening (not visible) (labially) and is provided for connection to an external suction unit (not shown) and for suctioning away a fluid and/or a liquid and/or solid drilling residue. It is also visible that the drill template 1 has an inner wall 1a oriented towards the inside of the mouth (orally), an upper wall 1c oriented towards the line of terminal occlusion (occlusally), and an outer wall 1b oriented outwardly in the tooth region (vestibularly), towards the cheek (see also FIG. 2), wherein the fluid-conducting element 4 is provided at least in part on and/or in the inner wall 1a, or is formed integrally with the inner wall 1a and the outer wall 1b and also the upper wall 1c.

FIG. 2 then shows a schematic three-dimensional depiction of the drill template 1 according to the invention from FIG. 1 from below, specifically with a view of the resting surface 1d enclosed by the walls 1a, 1b, 1c. In particular, the fact that the outer wall 1a and inner wall 1c enclose a cavity 5 (dotted line) is also clearly visible, wherein the cavity 5 is fuidically effectively connected to the through-opening 2 and is formed at least partially below the reinforcement region 2a. It can also be seen that the cavity 5 has a fluidically effective connection to the aperture 3 and thus also to the inlet 4a. It is also conceivable that a filter or a mesh-like element (not shown) is arranged between the inlet 4a of the fluid-conducting element 4 and the aperture 3 in order to prevent an infiltration of bone splinters into the fluid-conducting element 4.

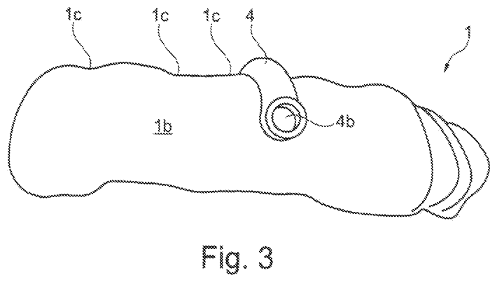

The outlet 4b in this depiction as well is oriented substantially towards the mouth opening (not visible) (labially). The labial orientation of the outlet 4b can be seen better in FIG. 3. Here, the drill template from FIG. 1 can be seen in a schematic three-dimensional depiction, specifically in a view from the front. An orientation towards the mouth opening additionally simplifies the connection of a suction assembly (not shown). It can also be clearly seen that the fluid-conducting element 4 extends from the inner wall 1a (not visible, see also FIG. 1), over the line of terminal occlusion or the upper wall 1c oriented thereover (occlusally), as far as the vestibular, in particular labial, outwardly oriented outer wall 1b.

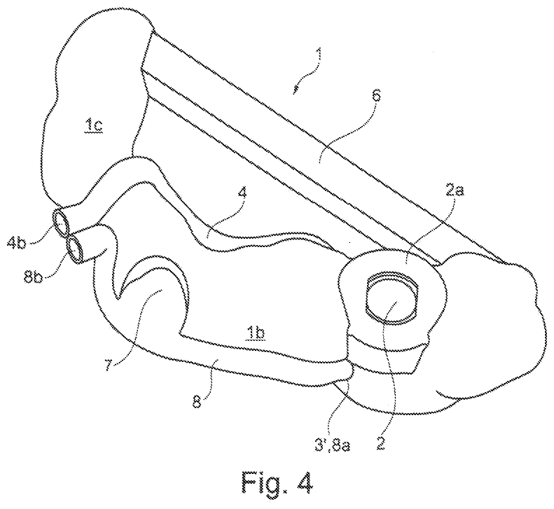

In FIG. 4, a schematic three-dimensional depiction of the drill template 1 from FIG. 1 and FIG. 2 with a further fluid-conducting element 8 is now sketched. Similarly to the fluid-conducting element 4, the fluid-conducting element 8 comprises an inlet 8a, which is moulded sealingly and fluidically effectively around an aperture, specifically the aperture 3′, or the fluid-conducting element 8 reaches through the aperture 3′, and ends below the reinforcement region 2a so that the inlet 8a is exposed there. Similarly to the aperture 3, the aperture 3′ also has a predetermined orientation.

The fluid-conducting element 8 is furthermore also tubular in this illustration. Alternatively, however, a flat-rectangular cross section is also conceivable. Also clearly visible is the fact that the outlet 8b of the fluid-conducting element 8 is oriented or positioned substantially towards the mouth opening (not visible) (labially) and is also provided for connection for an external suction unit (not shown) for suctioning away a fluid and/or a liquid and/or solid drilling residue. In order to bring together the outlet 4a and 8a, different adapters for a suction apparatus are conceivable. It can be clearly seen that the fluid-conducting element 8 is formed at least in part on and/or in the outer wall 1b. Similarly to the inlet 4a, the inlet 8a is positioned below the reinforcement region 2a and is fluidically effectively connected or connectable via the aperture 3′ to the cavity 5. It can also be seen that a viewing window 7 for visually inspecting the position is provided in the drill template 1, wherein the course of the fluid-conducting element takes into account the position of the viewing window 7. A bar 6 is also visible, which bar contributes to structurally reinforcing the drill template and can also be designed to form further resting surfaces 1d. It is also conceivable that the fluid-conducting element 4 is an integral part of the bar 6, wherein the fluid-conducting element 4 also runs completely inside the bar 6. Alternatively, the fluid-conducting element 8 can be provided here as well to introduce a fluid, in particular a gaseous fluid. An uninterrupted cooling of the implant bed without a traumatising rise in temperature in the bone may be ensured as a result, even if there is no coolant flow coupled to the drilling instrument or if the drill has been removed from the drill template.

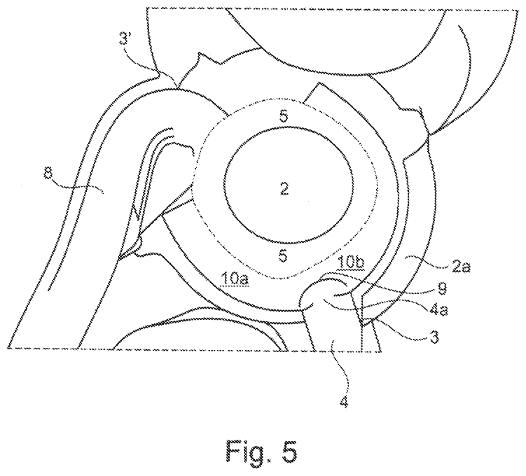

FIG. 5 now shows a preferred embodiment of the drill template 1 shown in FIG. 4. In particular, an enlarged detail around the reinforcement region 2a of the through-opening 2 is shown, as viewed from below. In order to show a view of the fluid-conducting elements 4 and 8 arranged in part in the drill template or integrated into the drill template 1, the outer wall 1a and the inner wall 1c as well as the resting surface 1d have been broken open or cut away. A cavity 5 (dot-dash line) is provided below the reinforcement region 2a.

In the broken-open view, the main course of the fluid-conducting elements 4 and 8 within the drill template 1 is now clearly visible. In particular, it is now also visible that the fluid-conducting element 4 has a branching 9.

The branching 9 is formed here relatively easily in that it divides the fluid-conducting element 4, in particular the inlet 4a, into two extensions 10a, 10b arranged within the reinforcement region 2a. It is provided that the coolant is suctioned away via the extensions 10a, 10b together with saliva, blood and abraded particles. To this end, the extensions 10a and 10b are open to the cavity 5 provided below the reinforcement region 2a and thus form an annular space. The annular space is therefore also positioned after the aperture 3 in the flow direction, wherein the aperture is closed tightly with the fluid-conducting element and therefore so too is the cavity 5, wherein the cavity 5 is fluidically effectively connected to the through-opening. In particular, the region around the cavity 5 rests or bears fluid-sealingly via the resting surface 1d against the patient's jaw, in particular against the gingiva.

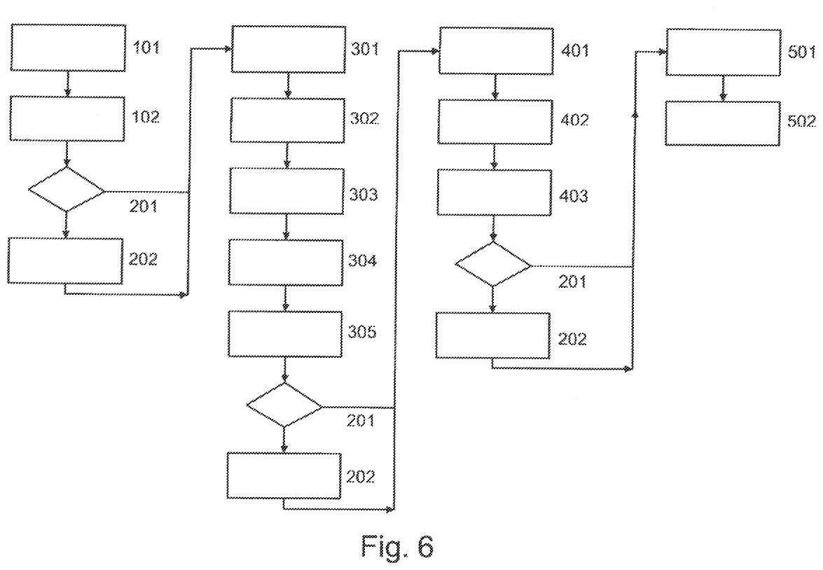

The corresponding method steps will be described in greater detail hereinafter with reference to FIG. 1 to FIG. 5 and FIG. 6.

Firstly, it is decisive in the case of the drill template 1 and the method that the drill template has a fluid-conducting element 4, wherein the course of the fluid-conducting element 4 takes into account the position or location and orientation of the implant defined in the virtual implant plan at the time of production of the virtual draft of the drill template 1. Furthermore, the position and orientation of so-called bars 6 and viewing windows 7 may also be taken into account. Effective suctioning at specific points is thus achievable and may also contribute to a structural reinforcement of the drill template.

In the embodiment of the method for the virtual draft and/or production of a drill template 1 for drilling an implant hole for a dental implant, a virtual implant plan, in particular a 3D implant plan, is firstly provided in step 101. In step 102, a design of a drill template 1 is then produced, wherein in particular the position or location and orientation of the through-opening 2 and of the aperture 3 and of the fluid-conducting element 4, in particular the course, is taken into account under consideration of the position or location and orientation of the implant defined in the virtual implant plan. The position and orientation of a viewing window 7 and of a bar 6 may also be taken into account (see also FIG. 4).

The method according to the invention may also comprise the following method steps, wherein in particular in step 201 the virtual draft of the drill template 1 is proposed to a user for approval, whereby the user again confirms the correctness of the design before a digital data set of the virtual drill template is produced, which is then transmitted to a device in order to produce a physical model. Alternatively, however, the user may also reject the proposal in step 202 in order to make changes to the virtual draft of the drill template 1, in particular the position or location and orientation of the through-opening 2 and of the aperture 3 and of the fluid-conducting element 4, in particular the course of the fluid-conducting element 4.

The course of the fluid-conducting element 4 (or also 8) may be easily defined as a design with the following method steps, wherein a straight connecting line V1 is calculated as step 301, which line connects a predetermined inlet coordinate KE of the inlet and a predetermined outlet coordinate KA of the outlet to one another. Similarly, in step 302, a straight connecting line V2 is calculated or determined on the basis of a predetermined inlet coordinate KE of the inlet and an implant (reference) coordinate KI. In step 303, a plane E1 which comprises at least the straight connecting lines V1 and V2 can now be calculated or spanned or defined. As step 304, the cutting line S of the plane E1 with the outer wall and/or the inner wall and/or upper wall of the drill template is now determined or calculated, and, in step 305, a fluid-conducting element 4 is produced around the cutting line S on this basis. The fluid-conducting element may for this purpose have a tubular or a flat-rectangular cross section. It is also conceivable that the fluid-conducting element 4 is easily moulded on one of the walls of the drill template or, alternatively, is an integral part of the drill template 1. As already explained, the method step 201 may also be performed here once more, wherein the previously produced or amended virtual model is proposed to a user for approval, whereby the user again must confirm the correctness of the design before a digital data set of the virtual drill template is produced, which is then lastly transmitted to a device in order to produce a physical model. Alternatively, however, the user may also reject the proposal in step 202 in order to make changes to the virtual draft of the drill template 1. Alternatively, as rendered in method step 401, the cutting line S may also be predefined at least in part by the determination of individual points Pi on the surface of the virtual draft of the drill template 1, in particular the inlet coordinate KE of the inlet and the outlet coordinate KA of the outlet. In method step 402, individual connecting lines Vi between the points Pi are then produced, wherein the connecting lines Vi are projected onto the surface of the virtual draft of the drill template 1 and thus map the cutting line S. On this basis, a fluid-conducting element 4 is now produced around the cutting line S in method step 403. The fluid-conducting element 4 may for this purpose have a tubular or a flat-rectangular cross section. It is also conceivable that the fluid-conducting element 4 is easily moulded on one of the walls of the drill template or, alternatively, is an integral part of the drill template 1. As already explained, the method step 201 may also be performed here once more, wherein the previously produced or amended virtual model is proposed to a user for approval, whereby the user again must confirm the correctness of the draft before a digital data set of the virtual drill template 1 is produced, which is then lastly transmitted to a device in order to produce a physical model. Alternatively, however, the user may also reject the proposal in step 202 in order to make changes to the virtual draft of the drill template 1. To conclude, at least one digital data set of the virtual drill template 1 is produced in method step 501, and on this basis a physical drill template is produced in method step 502 with the aid of an additive manufacturing method.

As a result, the disadvantages discussed at the outset are avoided and a multitude of advantages are provided.

### LIST OF REFERENCE SIGNS

1 Drill template

1a Inner wall oriented towards the oral cavity (orally)

1b Outer wall oriented towards the cheek (vestibularly)

1c Upper wall oriented towards the line of terminal occlusion (occlusally)

1d Resting surface

2 Through-opening

2a Reinforcement region

3 Aperture

4 Fluid-conducting element

4a Inlet

4b Outlet

5 Cavity

6 Bar

7 Window

8 Fluid-conducting element

8a Inlet

8b Outlet

9 Branching

10a, 10b Extension

1. A drill template (1) for drilling an implant hole for a dental implant, the drill template having a through-opening (2) and at least one aperture (3), wherein the drill template is provided or can be placed for resting or bearing against a jaw, palate and/or one or more teeth and is at least partially adapted to the geometry of the jaw, palate and/or one or more teeth, wherein the through-opening (2) is provided for guiding a drill, in particular a dental implant drill, and/or for inserting a guide sleeve for a drill, and wherein the aperture (3) is provided for conducting a fluid, characterised in that the drill template comprises a fluid-conducting element (4, 8).

2. The drill template according to claim 1,
characterised in that
the fluid-conducting element (4, 8) has an inlet (4a, 8a) and an outlet (4b, 8b), wherein the fluid-conducting element (4, 8) is fluidically effectively connected or connectable to the aperture (3, 3′) through the inlet (4a, 8a).

3. The drill template according to claim 1 or 2,
characterised in that
the orientation of the aperture (3, 3′) is determined or calculated on the basis of a direction vector.

4. The drill template according to one of claims 1 to 3,
characterised in that
the outlet (4a, 8a) of the fluid-conducting element is oriented substantially towards the mouth opening (labially) or towards the cheek (buccally).

5. The drill template according to one of claims 1 to 4,
characterised in that
the fluid-conducting element (4, 8) has a tubular or a flat-rectangular cross section.

6. The drill template according to one of claims 1 to 5,
characterised in that
the drill template has an outer wall (1a) oriented outwardly in the tooth region (vestibularly), towards the cheek, wherein the fluid-conducting element (4, 8) is provided at least partially on and/or in the outer wall (1a) or is formed integrally with the outer wall (1a).

7. The drill template according to one of claims 1 to 6,
characterised in that
the drill template has an inner wall (1b) oriented into the interior of the mouth (orally), wherein the fluid-conducting element (4, 8) is provided at least partially on and/or in the inner wall (1b), or is formed integrally with the inner wall (1b).

8. The drill template according to one of claims 1 to 7,
characterised in that
the drill template has an upper wall (1c) oriented towards the line of terminal occlusion (occlusally), wherein the fluid-conducting element (4, 8) is provided at least partially on and/or in the upper wall (1c), or is formed integrally with the upper wall(1c).

9. The drill template according to one of claims 1 to 8,
characterised in that
the fluid-conducting element (4, 8) is provided so as to at least partially follow the course of the outer wall (1a) and/or inner wall (1b) and/or the upper wall (1c).

10. The drill template according to one of claims 1 to 9,
characterised in that
the fluid-conducting element (4, 8) comprises or is produced comprising at least partially the outer wall (1a) and/or inner wall (1b) and/or upper wall (1c) or is formed integrally with the outer wall (1a) and/or inner wall (1b) and/or upper wall (1c).

11. The drill template according to one of claims 1 to 10,
characterised in that
the outer wall (1a) and inner wall (1b) enclose a cavity (5), wherein the cavity (5) is fluidically effectively connected to the through-opening (2).

12. The drill template according to one of claims 1 to 11,
characterised in that
a filter or a mesh-like element is arranged between the outlet (4b, 8b) of the fluid-conducting element (4) and the aperture.

13. The drill template according to one of claims 1 to 12,
characterised in that
the fluid-conducting element (4, 8) is provided for sucking up and/or suctioning away a liquid and/or solid drilling residue.

14. The drill template according to one of claims 1 to 13,
characterised in that
means for connection for suctioning away a fluid and/or a liquid and/or solid drilling residue is provided on or can be attached to the outlet (4b, 8b) of the fluid-conducting element (4, 8).

15. The drill template according to one of claims 1 to 14,
characterised in that
the fluid-conducting element (4, 8) has an inlet coordinate KE of the inlet (4a, 8a), and an outlet coordinate KA of the outlet (4b, 8b), and a cutting line S, wherein the cutting line S connects the inlet coordinate KE and the outlet coordinate KA to one another linearly.

16. The drill template according to one of claims 1 to 15,
characterised in that
the fluid-conducting element (4, 8) has a branching (9), in particular a plurality of branchings.

17. The drill template according to one of claims 1 to 16,
characterised in that
the drill template has a further fluid-conducting element (4, 8), wherein the fluid-conducting element (4, 8) is provided to introduce a fluid, in particular a gaseous fluid.

18. The drill template according to one of claims 1 to 17,
characterised in that
the drill template has a bar (6), wherein the fluid-conducting element (4, 8) is designed at least in part as an integral part of the bar (6).

19. A method for the virtual draft and/or production of a drill template for drilling an implant hole for a dental implant according to one of the preceding claims 1 to 18, comprising the following method steps:
providing a virtual implant plan, in particular a 3D implant plan,
producing a virtual draft of a drill template, wherein in particular the position or location and orientation of the through-opening (2) and of the aperture (3, 3′) and of the fluid-conducting element (4, 8), in particular the course, is taken into account under consideration of the position or location and orientation of the implant defined in the virtual implant plan.

20. The method according to claim 19, further comprising the following method steps:
calculating a straight connecting line V1 on the basis of a predetermined inlet coordinate KE of the inlet and an outlet coordinate KA of the outlet,
calculating a straight connecting line V2 on the basis of a predetermined inlet coordinate KE of the inlet and an implant (reference) coordinate KI,
calculating or spanning or defining a plane E1 which comprises the straight connecting lies V1 and V2,
calculating or determining the cutting line S of the plane E1 with the outer wall and/or inner wall and/or upper wall of the drill template,
generating a fluid-conducting element on the basis of the cutting line S.

21. The method according to one of preceding claim 19 or 20, further comprising the following method steps:
determining individual points Pi on the surface of the virtual draft of the drill template, in particular the inlet coordinate KE of the inlet and the outlet coordinate KA of the outlet,
generating individual connecting lines Vi between the points Pi, wherein the connecting lines are projected onto the surface of the virtual draft of the drill template and thus map a cutting line S,
generating a fluid-conducting element on the basis of the cutting line S.

22. The method according to one of preceding claims 19 to 21, further comprising the following method steps:
proposing the virtual draft of the drill template to a user for approval,
allowing the user to reject the proposal in order to make changes to the virtual draft of the drill template, in particular the position or location and orientation of the through-opening (2) and of the aperture (3, 3′) and of the fluid-conducting element (4, 8), in particular the course of the fluid-conducting element.

23. The method according to one of claims 19 to 22, further comprising the following method steps:
generating at least one digital data set of the virtual drill template,
generating a physical drill template with the aid of an additive manufacturing process on the basis of the digital data set.
